(19) United States
(12) Patent Application Publication
(10) Pub. No.: US 2018/0094804 A1
(43) Pub. Date: Apr. 5, 2018

(54) Pumpkin Display Stand

(71) Applicant: Danny Brannagan, Fruitland, UT (US)

(72) Inventor: Danny Brannagan, Fruitland, UT (US)

(21) Appl. No.: 15/722,374

(22) Filed: Oct. 2, 2017

Related U.S. Application Data
(60) Provisional application No. 62/402,115, filed on Sep. 30, 2016.

(51) Int. Cl. F21V 33/00; F16M 11/22; F16M 13/02; F21V 23/06

(52) U.S. Cl. CPC F21V 33/0028; F16M 11/22; F21Y 2107/20; F21V 23/06; F16M 13/022

(57) ABSTRACT

A pumpkin display stand is provided. The display stand includes a body including a planar member configured to receive an item, such as a pumpkin, thereon. Support members protruding upwardly from an upper surface of the body are configured to engage and support an item placed on the body. Fasteners removably attachable to the lower surface of the body are configured to secure the body to a surface. A plurality of bores disposed on a lower surface of the body are configured to removably receive the fasteners therein. A light assembly including a first light source and a second light source is configured to illuminate the interior and exterior of an item placed on the body. An electric port disposed on the body is configured to removably receive a power source for providing power to the light assembly.

### CROSS REFERENCE TO RELATED APPLICATIONS

This application claims the benefit of U.S. Provisional Application No. 62/402,115 filed on Sep. 30, 2016. The above identified patent application is herein incorporated by reference in its entirety to provide continuity of disclosure.

### BACKGROUND OF THE INVENTION

The present invention relates to display stands. More specifically, the present invention relates to a pumpkin display stand configured to removably receive and retain a pumpkin thereon, and including a light assembly configured to illuminate a pumpkin placed thereon.

Extravagant amounts of revenue is earned from pumpkin sales each year, most of which spent on pumpkins for ornamental use. Pumpkins have a hard, but penetrable rounded body, which enables them to be easily carved. However, the natural unevenness of a pumpkin body makes them hard for carving on surfaces. This is particularly dangerous since children often utilize sharp tools to carve pumpkin. Any slippage or sudden movement by the pumpkin can result in serious injuries.

Typically, after pumpkins are carved, they are illuminated for ornamental use as jack-o'-lanterns. Pumpkins are traditionally illuminated with candles or other lighting. Candles, particularly tea lights, are one of the most common ways to light a jack-o'-lantern. Candles, however, present a fire hazard, and need to be replaced frequently. Candles are often also a weaker light source and may be extinguished by wind or rain. Thus, there is a need in the art for a lighted display stand that is configured to stabilize a pumpkin safely thereon, while providing a light source for facilitating better illumination of a jack-o'-lantern.

### SUMMARY OF THE INVENTION

In view of the foregoing disadvantages inherent in the known types of display stands now present in the prior art, the present invention provides a pumpkin display wherein the same can be utilized for providing convenience for the user when carving and illuminating a pumpkin for ornamental use.

In one embodiment of the present invention, the pumpkin display stand comprises a body including an upper surface, a lower surface, and a sidewall disposed between the upper surface and lower surface. A plurality of support members protruding upwardly from the upper surface of the body include a pointed end configured to puncture an item placed on the body. A plurality of fasteners removably attachable to the lower surface of the body are configured to secure the body to a surface. A plurality of radial bores disposed on the lower surface of the body include an interior volume configured to removably receive and secure a fastener thereto. A light assembly including a first light source and a second light source in operable communication with each other is configured to illuminate an item placed on the body. The first light source is disposed in a center of the body for illuminating a center or interior of the item and the second light source is disposed on the sidewall of the body for illuminating the exterior surface of the. An electric port in operable communication with the light assembly is configured to couple the light assembly to a power supply. The electric port is disposed on the sidewall between an upper perimeter edge of the upper surface and a lower perimeter edge of the lower surface, such that the electric port is flush with the sidewall and capable of receiving a power plug when an item is mounted onto the body.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top perspective view of the pumpkin display stand according to one embodiment of the present invention.

FIG. 2 shows a bottom perspective view of the pumpkin display stand according to one embodiment of the present invention.

FIG. 3 shows a perspective view of the light assembly of the pumpkin display stand in an activated state according to one embodiment of the present invention.

FIG. 4 shows a perspective view of the pumpkin display stand supporting and an illuminating a pumpkin placed thereon according to one embodiment of the present invention.

### DETAILED DESCRIPTION OF THE INVENTION

Reference is made herein to the attached drawings. Like reference numerals are used throughout the drawings to depict like or similar elements of the pumpkin display stand. The figures are intended for representative purposes only and should not be considered to be limiting in any respect.

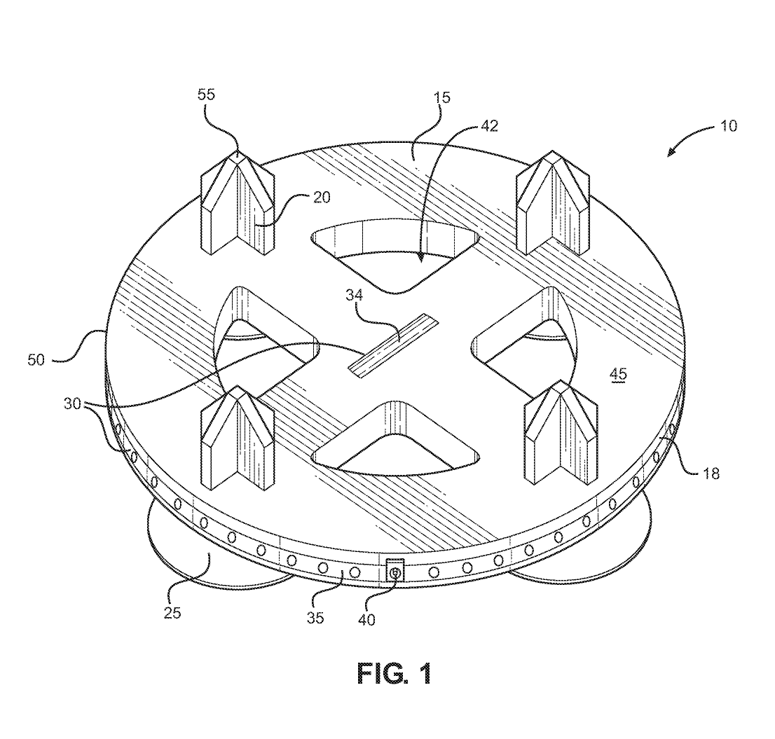

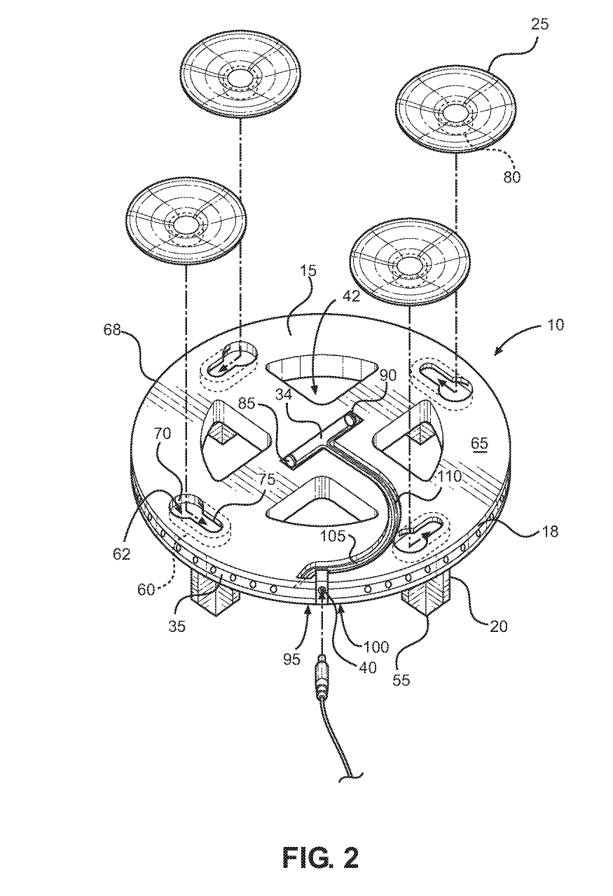

Referring now to FIGS. 1 and 2, there is shown a top perspective view of the pumpkin display stand and a bottom perspective view of the pumpkin display stand, respectively. The pumpkin display stand 10 of the present invention comprises a body 15 including a planar surface configured to receive an item thereon, a plurality of support members 20 configured to engage and support an item placed on the body 15, a plurality of fasteners 25 configured to secure the body 15 to a surface, a light assembly 30 configured to illuminate an item, such as a pumpkin, placed on the body 15, and an electric port 40 configured to removably receive a power source for providing power to the light assembly 30.

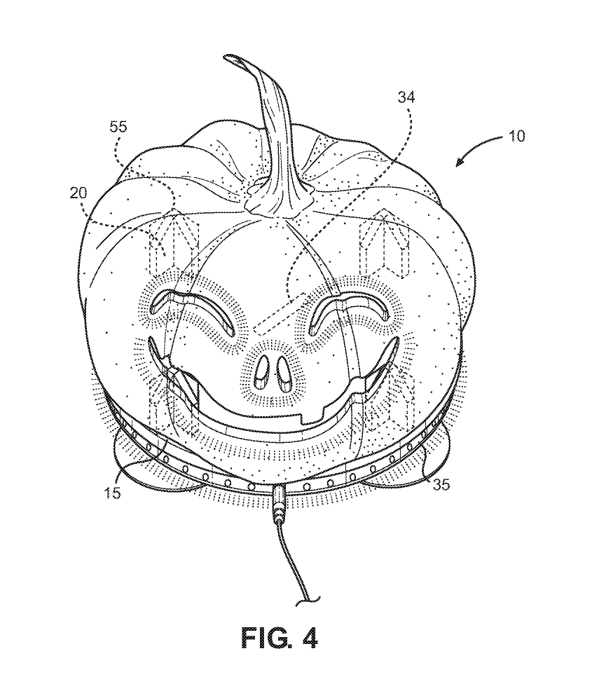

The body 15 comprises a transparent planar member configured to receive the bottom portion of a pumpkin or item thereon, as shown in FIG. 4. The transparency of the planar member enables light emitted by the light assembly 30 to propagate throughout the body 15, thereby enhancing illumination of an item placed on the body 15. The planar member includes an upper surface 45, a lower surface 65, and one or more sidewalls 18 disposed between the upper surface 45 and the lower surface 65. The one or more sidewalls 18 defines the perimeter of the body 15. In the depicted embodiment, the planar member comprises a circular plate corresponding to and accommodating round items, such as pumpkins, other cucurbits, and cakes placed on the body 15. However, in alternative embodiments, the planar member may comprise other polygonal shaped planar members. In the depicted embodiment, the planar member includes one or more longitudinal bores 42 extending through the body 15 from the upper surface 45 to the lower surface 65. The one or more longitudinal bores 42 are configured to make the display stand 10 lighter in weight for maneuvering it more easily in addition to serving as handle for facilitating grasping of the display stand 10.

The support members 20 protrude upwardly from the upper surface 45 of the body 15 and positioned around an upper perimeter edge 50 of the body 15. In the depicted embodiment, the support members 20 protrude perpendicularly relative to the upper surface 45 of the body 15 and are spaced evenly apart from each other around the upper perimeter edge 50 of the body 15. In this way, the support members 20 may impale an item placed on the body 15 and can provide evenly distributed support across the item, thereby helping preserve the integrity of the item. Each of the support members 20 includes a pointed end 55 configured to puncture the shell or exterior of an item placed on the body 15, so as to engage the item and secure it to the body 15, as shown by FIG. 4. In the depicted embodiment, each of the support members 20 comprises a cruciform-shaped stake, such that the stake may facilitate perforation of an item and maximize its holding power in order to securely retain heavier items thereon. In a preferred embodiment, the display stand 10 includes four support members 20 distributed evenly around the perimeter edge 50 of the body 15.

A plurality of radial bores 60 are disposed on a lower surface 65 of the body 15. The radial bores 60 are each configured to removably receive and secure a fastener of the plurality of fasteners 25 therein. The radial bores 60 define an interior volume 62 including a length extending laterally, or radially, across the body 15 between the upper surface 45 and lower surface 65 and tangentially relative to the sidewall 18 of the body 15. In the depicted embodiment, the radial bores 60 are disposed on a lower perimeter edge 68 of the lower surface 65 of the body 15, such that the radial bores 60 may receive the fasteners 25 close to the perimeter of the body 15. In this way, the fasteners 25, when secured to a surface, may provide even support to the body 15. In the depicted embodiment, the radial bores 60 are spaced evenly apart from each other around the lower perimeter edge 68 of the body 15. The radial bores 60 each include an opening 70 in communication with a channel 75 that includes a diameter less than a diameter of the opening 70. The openings 70 provide the fasteners 25 access to the interior volume 62 of the radial bore 60, while the channels 75 are configured to lock the fasteners within the radial bores 60.

The plurality of fasteners 25 each include a flange 80 for removably attaching the fasteners 25 to the radial bores 60. The flanges 80 each include a diameter less than a diameter of the each of the openings 70 of the radial bores 60, but greater than a diameter of the channel 75 of the radial bores 60. In this way, the opening 70 is sized to accept the flange 80 of the fastener 25 into the bore 60, while the channel 75 is configured to slidably receive and engage the flange 80 of the fastener 25 within the radial bore 60, as shown by FIG. 2, thereby securing the fastener 25 to the lower surface 65 of the body 15. When attached to the radial bores 60, the fasteners 25 protrude vertically outwardly, or downwardly, from the lower surface 65, thereby facilitating securement of the fasteners 25 to a surface and suspension of the body 15 above the surface. In the depicted embodiment, the plurality of fasteners 25 include suctions cups configured to adhere to a surface by creating a partial vacuum within an interior volume of the suction cup when pressed against a surface.

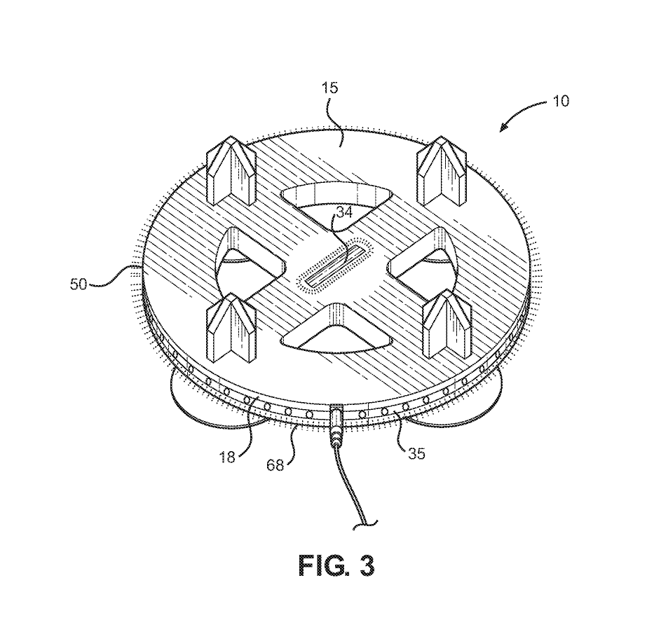

The light assembly 30 includes at least a first light source 34 and a second light source 35 in operable communication with each other. The first light source 34 is disposed in a center of the body 15, such that it is configured to emit light from a center of the display stand 10 and towards the interior of an item placed on the display stand 10 when activated, as shown by FIG. 3. The second light source 35 is disposed annularly around the sidewall 18 of the body 15 between the upper perimeter edge 50 and the lower perimeter edge 68 of the body 15, such that it is configured to emit light from the perimeter of the display stand 10 when activated, as shown by FIG. 3, thereby illuminating the exterior surface of an item placed on the display stand 10. In this way, the first and second light sources 34, 35 synergistically emit light all around the display stand 10, thereby optimizing the illumination of an item, such a pumpkin, placed on the body 15, as shown in FIG. 4. In one embodiment, the first and second light sources 34, 35 are embedded within the body 15, such that they do not protrude off of, or extend from, the sidewall 18, the upper surface 45, the lower surface 65, and the upper and lower perimeter edges 50, 68 of the body 15.

The electric port 40 is disposed on the sidewall 18 between the upper surface 45 and the lower surface 65 of the body 15, such that the port 40 is positioned flush within the sidewall 18 between the upper perimeter edge 50 and the lower perimeter edge 68 of the body 15, thereby enabling port to receive a power plug when an item is mounted onto the body 15. The port 40 is in communication with the light assembly 30 and configured to removably receive a power plug to provide power to the light assembly 30. In the depicted embodiment, the port 40 includes a female DC/AC adapter socket configured to interchangeably receive either a male DC/AC power plug of a battery pack or a male DC/AC power plug of a power cord for plugging into a power outlet and receiving continuous power.

In the depicted embodiment, the first light source 34 includes a light bar and the second light source 35 includes a flexible light strip. The light bar includes a positive terminal 85 and a negative terminal 90 in electrical communication with a first end 95 of the light strip, while the port 40 is in electrical communication with a second end 100 of the light strip. In this way, the port 40 is capable of providing power to the first and second lights sources 34, 35. The positive and negative terminals 85, 90 are in electrical communication with the first end 95 of the light strip via wires 105 embedded within a groove 110 on the lower surface 65 of the body 15. The groove 110 prevents the wires 105 from being exposed, thereby preserving the wires 105 integrity.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A display stand, comprising:
a body including an upper surface, a lower surface, and a sidewall disposed between the upper surface and lower surface, the sidewall defining a perimeter of the body;
a plurality of support members protruding upwardly from the upper surface of the body, each of the plurality of support members including a pointed end configured to puncture an item placed on the body;
a plurality of fasteners removably attachable to the lower surface of the body, the plurality of fasteners configured to secure the body to a surface;
a light assembly including a first light source and a second light source in operable communication with each other, the first light source disposed in a center of the body and the second light source disposed on the sidewall of the body.

2) The display stand of claim 1, wherein the body comprises a transparent planar member including a longitudinal bore extending longitudinally therethrough, the longitudinal bore extending from the upper surface to the lower surface.

3) The display stand of claim 1, wherein the plurality of support members protrude perpendicularly upwards relative to the upper surface of the body.

4) The display stand of claim 3, wherein the plurality of support members are disposed around an upper perimeter edge of the upper surface of the body, each of the plurality of support members evenly spaced apart relative to each other around the upper perimeter edge.

5) The display stand of claim 1, wherein each of the plurality of support members comprises a cruciform-shaped stake.

6) The display stand of claim 5, wherein the plurality of support members comprise four cruciform shaped stakes.

7) The display stand of claim 1, further comprising a plurality of radial bores disposed on the lower surface of the body, the radial bores defining an interior volume configured to removably receive and secure a fastener of the plurality of fasteners thereto.

8) The display stand of claim 7, wherein each of the interior volumes of the plurality of radial bores includes a length extending laterally across the body and tangentially relative to the sidewall of the body.

9) The display stand of claim 7, wherein each of the plurality of radial bores includes an opening providing access to the interior volume of a corresponding radial bore and a channel including a diameter less than a diameter of the opening;
wherein each opening is configured to removably receive a fastener of the plurality of fasteners; and
wherein each channel is configured to slidably engage a fastener received by the opening, thereby securing the fastener to the radial bore.

10) The display stand of claim 7, wherein the plurality of fasteners protrude vertically outwardly from the lower surface of the body when attached to a radial bore of the plurality of radial bores.

11) The display stand of claim 9, wherein each of the plurality of fasteners includes a flange including a diameter less than a diameter of each of the openings of the plurality of radial bores, but greater than a diameter of each of the channels of the plurality of radial bores, such that each of the openings is configured to receive the flange and each of the channels is configured to secure the flange within the interior volume of a corresponding radial bore.

12) The display stand of claim 9, wherein the plurality of radial bores are disposed around a lower perimeter edge of the lower surface of the body, each of the plurality of radial bores evenly spaced apart relative to each other around the lower perimeter edge.

13) The display stand of claim 12, wherein the plurality of radial bores comprises four radial bores.

14) The display stand of claim 13, wherein the plurality of fasteners comprises four fasteners, each of the four fasteners corresponding to a radial bore of the four radial bores.

15) The display stand of claim 10, wherein the plurality of fasteners comprises suction cups.

16) The display stand of claim 1, wherein the light assembly is embedded within the body, such that the first and second light sources do not protrude off of the sidewall, the upper surface, or the lower surface of the body.

17) The display stand of claim 1, wherein the second light source extends annularly around the entire sidewall of the body.

18) The display stand of claim 1, further comprising an electric port in operable communication with the light assembly, the electric port disposed on the sidewall of the sidewall between an upper perimeter edge of the upper surface and a lower perimeter edge of the lower surface, such that the electric port is flush with the sidewall;
wherein the electric port is configured to couple the light assembly to a power supply.

19) The display stand of claim 18, wherein the electric port comprises a female port configured to interchangeable receive a male plug of a battery or a male plug of a power cord for connecting to a power outlet of a structure.

20) The display stand of claim 18, wherein the first light source includes a positive and negative terminal in electrical communication with a first end of the second light source and the electric port is in electric communication with a second end of the second light source, thereby establishing an electrical communication in which the electric port is configured to power the first light source and second light source upon connection to a power supply.
